(19) United States
(12) Patent Application Publication
(10) Pub. No.: US 2006/0143706 A1
(43) Pub. Date: Jun. 29, 2006

(54) Security control apparatus, security control method, and storage medium

(76) Inventors: Hitomi Kawasaki, Akashi-shi (JP); Miho Murakami, Habikino-shi (JP); Momoyo Nakanishi, Yamatokoriyama-shi (JP)

Correspondence Address: OSTROLENK FABER GERB & SOFFEN, 1180 AVENUE OF THE AMERICAS, NEW YORK, NY, 100368403, US

(21) Appl. No.: 11/317,730

(22) Filed: Dec. 23, 2005

(30) Foreign Application Priority Data
Dec. 28, 2004 (JP) P2004-378354

(51) Int. Cl. G06F 12/14; G06F 12/00; G06F 13/00; G06F 17/30; G06F 7/04; G06F 7/58; G06K 19/00; G11C 7/00; H04L 9/32

(52) U.S. Cl. 726/19

(57) ABSTRACT

An instrument converts to a security mode that disallows normal operations at the same time as it converts to a power saving mode that achieves a reduction in power consumption and the like when a preset power saving mode transition time has elapsed. In this security mode, background processing relating to each function is executed and, if some type of input is received, security mode termination processing is started, a password input screen is displayed, and the instrument enters a password input standby state. If the password input standby state is left on, and a preset security mode re-transition time that is shorter than the power saving mode transition time lapses, the instrument is restored to the security mode and power saving mode that existed prior to the start of the termination processing.

### BACKGROUND OF THE INVENTION

1. Field of the Invention

The present invention relates to security control technology that determines whether or not functional use is possible in various instruments, and controls the security of the relevant functional use.

Priority is claimed on Japanese Patent Application No. 2004-378354, filed Dec. 28, 2004, the contents of which are incorporated herein by reference.

2. Description of Related Art

A large number of instruments, particularly electronic instruments such as computers and image forming apparatuses are provided with an operating mode that temporarily stops operations of fixed functions when the instrument is not used for a predetermined time or the like in order to reduce power consumption or control information or the like. Typical examples of these are the suspend mode that is designed to save electricity and screen savers that are designed to protect a screen that are started up on a normal computer. In order to restore functional operations that have been temporarily halted by these types of operation mode, in some cases it is sufficient simply to perform an optional operation that provides some type of input, however, in some cases authorization using password input or the like is also required. The trend in recent years has been for authorization requests to increase in order to strengthen security because of demands for information control and the diversification of operation functions and the like. Prior technologies relating to such authorization include the following.

Japanese Unexamined Patent Application, First Publication No. H09-34577 discloses a technology in which, in a personal computer that enters a power saving operation suspend mode when a predetermined time has passed since the last user input or when the duration of a system operation wait state reaches a set time or greater, at the resume time a password input is requested if the duration of the suspend mode has exceeded a preset time, while no password input is requested if the suspend mode has not exceeded a preset time. In this technology, operations are resumed from a suspend mode while a balance is maintained between system security and usability by requesting a password in accordance with the possibility of whether or not a user has simply left their seat.

Japanese Unexamined Patent Application, First Publication No. 2002-341701 discloses restore verification processing when a state prior to the execution of autoclear processing is restored in an image forming apparatus that executes autoclear processing to return the various processing settings to their normal state when a predetermined time has passed in an idling state after an operation key input or after processing has ended. This restore verification processing prevents control operations by non-controller general users when the state prior to the execution of the autoclear processing was in the middle of control operations for the various settings and the like by displaying the fact that the state to be restored is a control operation, and by requesting that a password be input or that a predetermined restore operation be performed.

Japanese Unexamined Patent Application, First Publication No. H05-324559 discloses an information control apparatus used by doctors to access patient examination data and the like. This information control apparatus terminates the display of a display unit if there is no new input within a preset period after the input ceased, or else shifts the screen to one that can be left on view and requests a password input and an input of key information verifying access rights when the doctor wishes to again access information.

Japanese Unexamined Patent Application, First Publication No. 2003-281336 discloses a system in which a server provides information on whether the users of each client are present. In this system, if the information processing terminals of a client are not operated for a predetermined time or longer, a screensaver is started up. The screensaver is then terminated by the input of a password and notification is made to the server from the information processing terminal that the user is present.

In an authorization that is made by the input of a password such as that described above, ordinarily, a display is shown on the display unit urging that authorization information such as a password be input, and when such input is received via a key operation or the like a comparison is made between this input authorization information and authorization information that has been stored in advance. Accordingly, each time functional operations that had been temporarily halted are restored, it is necessary to operate the display unit, the input device, the storage device, and the control unit in the respective stages of the authorization process.

In contrast to this, if a third party illegally restores functional operations in order to steal information, the functional operations cannot be restored if the authorization information is not known. However, because the authorization process has been implemented, several devices such as the display unit have been operated. In addition, the apparatus may be left in a state of waiting for the authorization information input, or the processing may be executed for incorrect authorization information. A system is widely employed in which, if the input authorization information is not correct, a request is made for the authorization information to be input again. As a result, the situation currently is that the apparatus is often left in a state of waiting for the authorization information to be input.

Namely, if a third party who is ignorant of the authorization information attempts to restore a functional operation, unnecessary operations are executed due to the implementation of the authorization process, and the state while these unnecessary operations are being executed is the same as the apparatus being put out of use. Because of this, when restoring an apparatus from a suspend mode or the like that allows a reduction in power consumption to be achieved, power ends up being consumed which contradicts the original purpose. For example, a display operation by the display unit in order to request a password input continues for no reason, and even furnishing an apparatus with an operating mode such as a suspend mode becomes meaningless.

Moreover, the state of waiting for an authorization information input is a temporary state during the implementation of an authorization process of an authorization that is intended to strengthen security, and it is intended that the authorization information will be received immediately and that the process will then move to the subsequent steps. Therefore, this unused state is definitely not preferable from the viewpoint of security control. For example, in an image forming apparatus or the like that is shared by a plurality of users, if, in an authorization information input standby state, a display requesting a password input is left as it is, then the continued notification of the fact that it is necessary to input a password or the like in order to restore functional operations that had been temporarily halted is also meaningless. Furthermore, a user who is trying to use a function requiring an operation different from this functional operation must perform the annoying task of canceling the paused state creating the problems of an increase in the burden on the user and a deterioration in the function utilization efficiency.

### SUMMARY OF THE INVENTION

The present invention was conceived in view of the above described circumstances, and it is an object thereof to provide a security control technology that, in cases such as when an attempt is made to restore functional operations that had been temporarily suspend, makes it possible to eradicate any harm that is caused by leaving an apparatus in a state of waiting for an authorization information input, that ensures the effectiveness of operating modes that temporarily suspend functional operations, and that achieve suitable security control in functional use.

In order to achieve the above described object, the security control apparatus of the present invention includes: a transition device that, when a preset transition time has elapsed, executes transition to a first state of a security mode in which function use by normal operation of an instrument is disallowed; an input requesting device that, in this security mode, requests an input of authorization information that is used for authorization to permit the function use; and a restoring device that, when a preset re-transition time that is shorter than the transition time has elapsed while in a second state of waiting for the input of the authorization information, restores the first state of the security mode.

In this security control apparatus it is possible for the transition time to be the duration of a period of non-use of the instrument in which it executes transition to an invalid mode that invalidates at least one function of the instrument, for the transition device to execute transition to the security mode at the same time as it executes transition to the invalid mode when the transition time has elapsed. Here, the invalid mode may places function operations of the instrument in a temporarily suspended state.

Moreover, it is also possible for the instrument to be an image forming device. A first example of this is an instrument that is an image forming device having a storage device that temporarily saves data of a read image, and in which there is further provided a deleting device that, when temporarily saved data is remaining in the storage device, deletes the data in the security mode. A second example of this is an instrument that is an image forming device having a function of receiving print data and executing a print output, and in which there are further provided: a first print restricting device that, when the image forming device receives print data while in the security mode operating state, saves the print data but does not allow a print output of the image forming device to be executed; and a first print executing device that, when the authorization information is input and the function use is permitted, causes a print output of the print data on the image forming device. A third example of this is an instrument that is an image forming device having a function of receiving a fax and executing a print output, and in which there are further provided: a second print restricting device that, when the image forming device receives a fax while in the security mode operating state, saves the received fax data but does not allow a print output of the image forming device to be executed; and a second print executing device that, when the authorization information is input and the function use is permitted, causes a print output of the received data on the image forming device.

In addition, the security control method of the present invention includes: a first step in which, when a preset transition time has elapsed, executing transition to a first state of a security mode in which function use by normal operation of an instrument is disallowed; a second step of, in this security mode, requesting an input of authorization information that is used for authorization to permit the function use; and a third step of, when a preset re-transition time that is shorter than the transition time has elapsed while a second state of waiting for the input of the authorization information still exists, restoring the first state of the security mode.

In addition, the storage medium of the present invention executes on a computer: a first procedure of, when a preset transition time has elapsed, executing transition to a first state of a security mode in which function use by normal operation of an instrument is disallowed; a second procedure of, in the security mode, requesting an input of authorization information that is used for authorization to permit the function use; and a third procedure of, when a preset re-transition time that is shorter than the transition time has elapsed while a second state of waiting for the input of the authorization information still exists, restoring the first state of the security mode.

According to the present invention, when an instrument is on a security mode that does not allow function use of the instrument by normal operation, and, in an authorization information input waiting a second state for permitting function use, a re-transition time has elapsed that is shorter than the transition time that was previously reached in order to enter the security mode, the first state of the security mode is once again restored. As a result, when deciding whether or not function use is possible in a variety of instruments, it is possible to avoid a situation in which an authorization information input standby state continues for too long. Accordingly, it is possible to prevent any harm that may result from the instrument being left in the authorization information input standby state, and reliable security control of function uses can be achieved.

Moreover, according to an embodiment in which the duration of a period of non-use of an instrument that converts to an operating mode in which the function operations of the instrument are temporarily suspended is set as the transition time, and the instrument converts to a security mode at the same time as it converts to this operating mode, in particular, when temporarily suspended function operations are being restored, it is possible to achieve precise security control of the function operations, and it is possible to ensure the effectiveness of the operating mode and achieve a reduction in power consumption and the like by leaving the function operations in a suspended state. Furthermore, according to an embodiment in which, when temporarily saved data is left remaining in the storage device, this data is deleted in security mode, unnecessary data is deleted in the security mode operating state which also contributes to the safety and the like of the information control.

### BRIEF DESCRIPTION OF THE DRAWINGS

FIG. 1 is a view showing the structure of an MFP, which is an image forming device to which the security control apparatus of an embodiment of the present invention has been applied.

FIG. 2 is a flowchart showing a processing flow in order to implement operations of a power saving mode and a security mode in the MFP shown in FIG. 1.

### DETAILED DESCRIPTION OF THE INVENTION

(Structure)

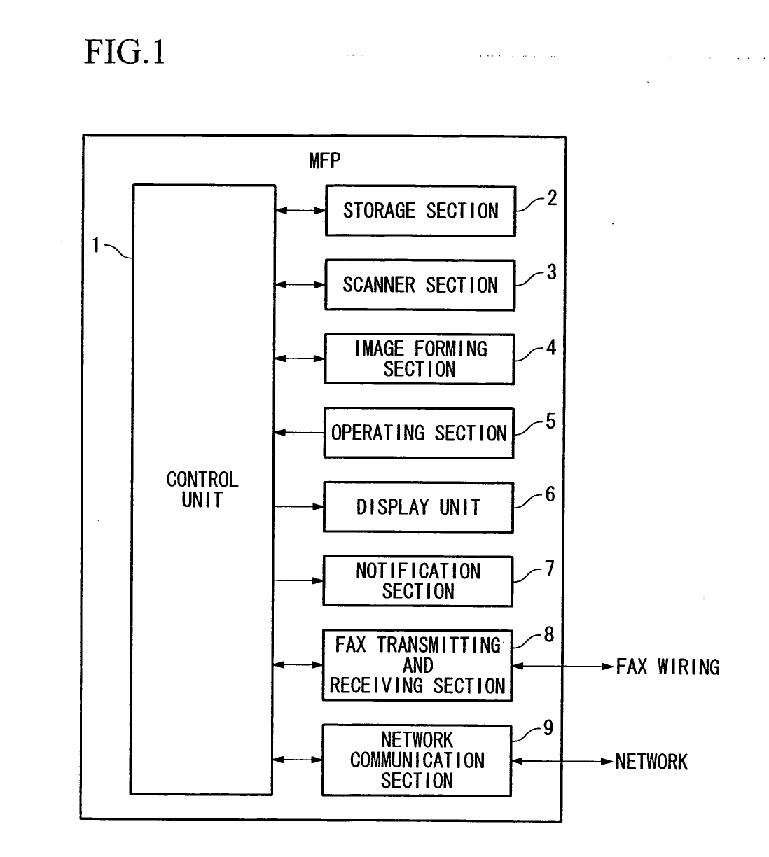

An embodiment of the present invention will now be described with reference made to the drawings. FIG. 1 is a view showing the structure of a multi-function printer (MFP) that is an image forming apparatus in which the security control method according to an embodiment of the present invention has been applied. As is shown in FIG. 1, this MFP has a control unit 1, a storage section 2, a scanner section 3, an image forming section 4, an operating section 5, a display unit 6, a notification section 7, a fax transmitting and receiving section 8, and a network communication section 9. This MFP is a multi-function machine and is provided with a combination of the functions of a photocopier, a printer, a scanner, and a fax transmitter and receiver. The use of these functions can be shared by a plurality of users.

The control unit 1 is a control device having a calculation section such as a CPU that executes calculation processing for a variety of information processing, non-volatile memory such as ROM in which is stored system information and the like that is required to start up the MFP, and semiconductor memory such as cache memory and RAM that, as a storage area for work performed by the calculation section, stores updatable information. The control unit 1 governs operations such as information processing inside the MFP, operation control of each of the sections, and information transfers with the outside. The photocopier, printer, scanner, and fax machine functions of the MFP (refererd to below respectively as the “copy function”, “printer function”, “scanner function”, and fax function”) are achieved by operations performed mainly by the control unit 1.

The storage section 2 is a storage device constituted by non-volatile memory such as an electrically erasable programmable ROM (EEPROM) and a hard disk. Programs and files such as information processing programs and control programs executed by the control unit 1 are stored in advance in the storage section 2, and when the respective functions of this MFP are in operation, data files such as image data for image data processing are also occasionally stored in the storage section 2. The program files stored in the storage section 2 include files for energy conservation programs that regulate the processing operations in power saving mode (invalid mode), and files for security mode programs that regulate the processing operations in the special security mode of this MFP.

Here, the power saving mode is an operating mode that is intended to achieve a saving in the power that is consumed during a state of waiting for an input to start up functional operations, and to reduce wear or prevent any deterioration in parts that maintain a constant movement even during a wait state. In the power saving mode programs that are stored in the storage section 2, a power saving mode is provided in which operations that maintain a standby state during normal running in which the copy function, printer function, scanner function, and fax function operate in conjunction with the input of a user are suspended, and the operations of each function are placed in a temporarily suspended state. When this MFP remains in a state of non-use (i.e., when a state in which none of the copy function, printer function, scanner function, and fax function can be used and no action is taken relating to the various settings—this also applies below) for an extended period and, while in a standby state, a preset power saving mode conversion time (transition time) elapses, a power saving mode program is started up, and the MFP converts to a power saving mode (i.e., the MFP makes a transition to a power saving mode).

On the other hand, the security mode is an operating mode that stops normal actions that operate and use the copy function, printer function, scanner function, and fax function, and decides whether or not functional use is possible by implementing an authorization process. In the security mode programs that are stored in the storage section 2, a security mode is provided that does not accept input from actions performed during normal running that is intended to start up the operations of the respective functions, and implements an authorization process based on password input so as to decide whether or not to allow action during normal running. In this MFP, because the operation of each function is temporarily suspended when the apparatus converts to a power saving mode, this temporary suspension mode becomes the object to which the security mode is applied, and background processing relating to each function is appropriately executed in security mode, while a restoral from the power saving mode of operations that are associated with the misuse or erroneous use of each function is prevented. The specific content of the security mode that operates organically together with the power saving mode is made clear in the following description of the operation thereof.

The scanner section 3 is a device that reads documents to be copied, scanned, or transmitted by fax. The scanner section 3 reads documents that have been set on a document tray (not shown) under the control of the control section 1, and supplies data from read documents to the control unit 1. Note that, if required, the scanner section 3 may be equipped with an automatic document feeder that sequentially feeds a plurality of document sheets to the document tray.

The image forming section 4 is an image forming device that is provided with a paper feed section that feeds sheets of material such as printing paper, a transfer section that transfers toner images onto the fed sheet material, a fixing section that performs fixing processing to fix the toner images that have been transferred onto the sheet material using heat from a heater, and a discharge section that discharges the sheets of material after the toner images have been fixed thereon. The image forming section 4 performs the processing sequence to form an image under the control of the control unit 1. For example, when the copy function is started up, the scanner section 3 reads a document that has been set on the document tray and data from this read document is supplied by the control unit 1 to the image forming section 4 as image data. The image forming section 4 then performs image formation processing based on the supplied image data. Note that the paper feed section is provided with a plurality of paper feed tiers in which cut paper that is used for the printing paper is set, and cut paper that is fed from the paper feed tier selected from these tiers is used as the sheet material during image formation.

The operating section 5 is an input device for inputting operation commands and operation settings into the MFP. The operating section 5 has a touch panel made up of a CRT display panel or an LCD panel, and is formed by the variety of operating keys placed on the touch panel and hard keys that are provided if necessary. The operating section 5 receives input from a user via a key operation and supplies this input to the control unit 1. The display unit 6 is formed by the touch panel CRT display or LCD or the like, and, under the control of the control unit 1, displays settings relating to the processing operations of the MFP, the operating state, and messages and the like to a user requesting input.

The notification section 7 is a sound generating device that is driven and controlled by the control unit 1, and generates a notification sound (e.g., a buzzer sound or a melody) to warn of abnormalities and the like.

The fax transmitting and receiving section 8 has a communication interface that is connected to fax wiring, and is a transmitting and receiving section for faxes while functioning as a fax modem for the MFP. The fax transmitting and receiving section 8 receives image signals of a fax being sent from the MFP from the control unit 1 and forwards it to the fax wiring. In addition, it receives image signals transmitted from the fax wiring and supplies them to the control unit 1.

The network communication section 9 has a communication interface that is connected to a network such as a LAN, and conducts information communication between other computers such as personal computers (not shown) that are connected to the network and its own MFP. As a result of the control unit 1 transferring information with other computers via the network communication interface 9, this MFP is able to function as a printer used by a plurality of computers (i.e., shared by a plurality of users), and is also able to function as a server.

Note that, although omitted from the drawings, a variety of sensors are provided in the MFP. These include a sensor that detects the amount of toner remaining in the waste toner transport path, a temperature sensor that detects the temperature of the fixing heater, and a humidity sensor that detects the humidity inside the apparatus.

(Operation)

A description will now be given of the operation of an MFP having the above described structure. This MFP functions as a photocopier, a printer, a scanner, and a fax machine that can be shared by a plurality of users, and also functions as a server for computers that are connected to a network. These functions themselves are the same as those of a normal shared MFP that has a server function, however, this MFP achieves a unique operation mode in which a power saving mode and a security mode act organically using the power saving mode program and the security mode program that are stored in the storage section 2. In addition, this operation mode has aspects that are also related to the server function in addition to the copy function, printer function, scanner function, and fax function. The unique operation mode of this MFP is also applied to these functions as well. Therefore, in the description below, a description of the operation of each actual function is omitted as these are the same as in a normal shared MFP, and a description is given of the operations of the unique energy conservations mode and security mode of the present MFP.

When an operation of the power saving mode is implemented, a duration of a state of non-use that will cause the MFP to change to a power saving mode is set in advance as an energy conservation conversion time (transition time). This setting is made by performing a key operation using the operating section 5, and the power saving mode conversion time is stored in a storage area (i.e., the storage area 2 or the RAM of the control unit 1 of the like) that is able to be referred to by the control unit 1.

When an operation of the security mode is implemented, a validation or non-validation of a conversion (transition) to security mode at the time of the conversion to the power saving mode, a password, and security mode reconversion time (re-transition time) are set in advance. These settings are also made by performing a key operation using the operating section 5, and the respective setting contents are stored in a storage area that is able to be referred to by the control unit 1.

The validation or non-validation of a conversion (transition) to security mode at the time of the conversion to the power saving mode is a setting that is determined in advance regarding whether or not the MFP will convert to security mode at the time of the conversion to the power saving mode. If conversion to the security mode is validated by performing a key operation using the operating section 5, then the security mode program is started up at the time of the conversion to power saving mode and the MFP converts to security mode (first mode) at the same time as it converts to power saving mode. This validation or non-validation of the conversion to security mode can be dealt with flexibly by providing modes that a specific user such as an administrator is able to set.

The password is authorization information used when making an authorization to permit operations during normal running (i.e., use of the copy function, printer function, scanner function, or fax function) in security mode. The password is made up of suitably selected characters and symbols and is input by performing a key operation using the operating section 5 and is saved (i.e., registered) by being stored in a storage area that is able to be referred to by the control unit 1. This setting may be made by a specific user such as an administrator, or by legitimate individual users that are permitted to use the respective functions. However, the password that is set is made known in advance only to legitimate users.

The security mode reconversion time is a wait time from when security mode termination processing has commenced until the apparatus is converted again to the security mode that was in operation prior to the commencement of the termination processing. In security mode, because normal operations are permitted if an authorization process using a password input is implemented and authorization is given, the security mode is terminated as a result thereof. Accordingly, the security mode termination processing includes an authorization process involving the input of a password, and there is a wait time during the termination processing while the MFP is on a state (second state) waiting for the password input. Therefore, the MFP measures the duration of the password input wait time, and when a predetermined wait time has lapsed the MFP converts again to the security mode that was in operation prior to the termination processing (this is described below in detail). This predetermined wait time is set in advance as the security mode reconversion time. This security mode reconversion time is a setting that is unique to this MFP, and various forms of the security mode reconversion time that is set exist. In the operation description given here, an example is used in which half of the power saving mode conversion time is set as the security mode reconversion time, however, the form of the security mode reconversion time that is set is described further below.

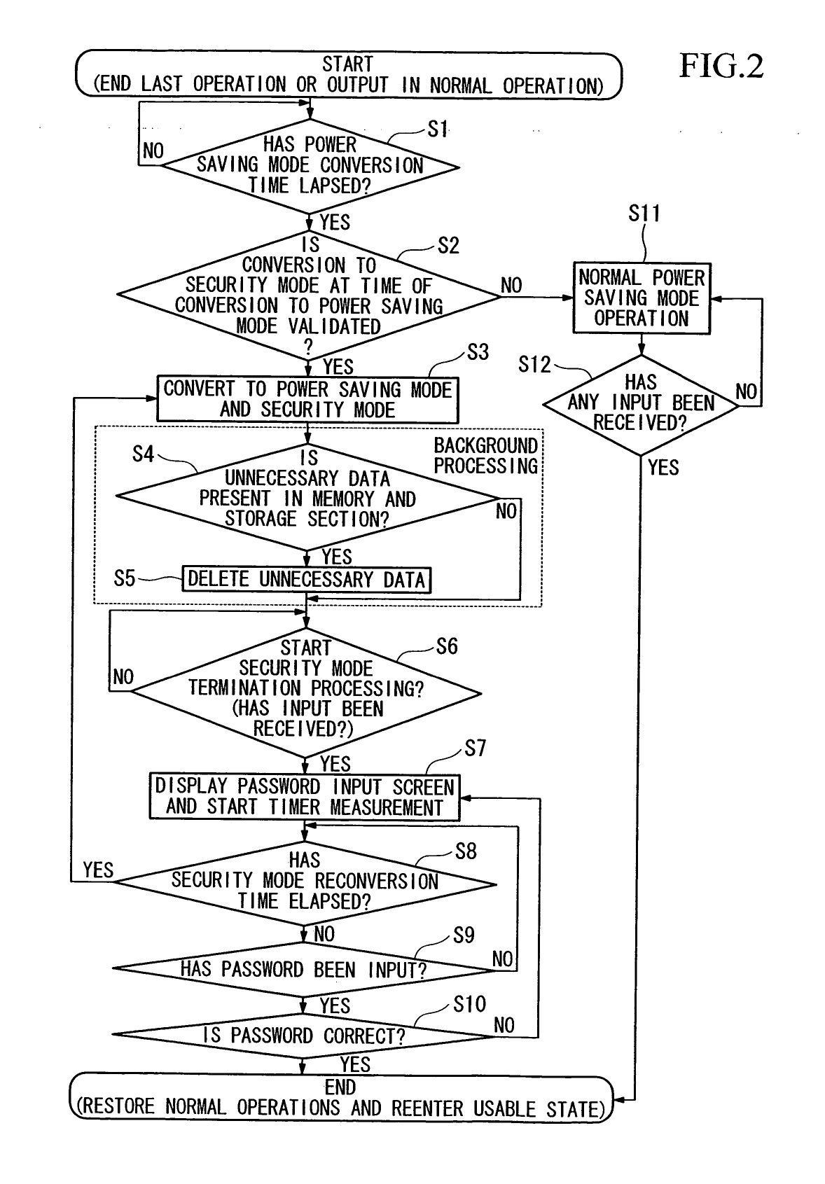

When the above settings are made and the MFP enters an unused state, processing is executed in order to implement operations of the power saving mode and security mode. FIG. 2 is a flow chart showing the sequence of this processing.

The MFP enters an unused state when there has been no user input during normal operation and when the last of the print outputs by the copy function or the like has ended. Accordingly, the processing to implement operations in power saving mode and security mode commences from a point when the last user manipulation or output in normal operation has ended. The control unit 1 measures the duration of the unused state from this point in time, and waits until the power saving mode conversion time has lapsed (step S1). The standby state at this time is a normal operation standby state in which the copy function, printer function, scanner function, and fax function can be operated correspondingly to the manipulation of a user. The lapse of the power saving mode conversion time is judged by determining whether or not the duration of the unused state that is being measured by the control unit 1 has reached the power saving mode conversion time that is based on the above setting. The normal operation standby state is maintained until the power saving mode conversion time has lapsed (i.e., while the result of the determination in step S1 remains as NO). However, if there is an input from a user prior to the power saving mode conversion time lapsing, an operation corresponding to the relevant input is started up and the unused state is ended. Therefore, the control unit 1 resets the duration of the unused state and once again measures the duration of the unused state from the point in time when the operations ended. As a result, the apparatus enters a normal operation standby state until the power saving mode conversion time once again lapses. Eventually, even in an unused state, as long as the duration of a particular unused state does not reach the power saving mode conversion time, the MFP apparatus remains in a normal operation standby state (i.e., the routine does not move to the subsequent step as long as the result of the determination in step S1 remains NO).

If this normal operation standby state continues and the duration of the unused state reaches the power saving mode conversion time and passes the power saving mode conversion time, then a determination is made as to whether or not a conversion to security mode is valid at the time of the conversion to the power saving mode (i.e., the result of the determination in step S1 is YES, and the routine moves to step S2).

Now, if the security mode conversion at the time of the power saving mode conversion has been validated in the above described setting, then it is determined by the control unit 1 that has referred to this setting that a conversion (transition) to security mode is valid, and the MFP converts to power saving mode and security mode (i.e., the result of the determination in step S2 is YES and the routine moves to step S3). Namely, as a result of the power saving mode conversion time elapsing, the power saving mode program is started and the MFP converts to power saving mode. In addition, at the same time as this, the security mode program is also started up and the MFP converts to security mode.

In power saving mode, operations to maintain the normal operation standby state are suspended, and operations of the copy function, the printer function, the scanner function, and the fax function are placed in a temporarily suspended state. The specific operations that are suspended may be selected to so as to contribute to reducing power consumption or reducing the wear on moving parts and the like and stipulated in the power saving mode program. For example, display operations of the display unit 6 may be suspended (i.e., the screen display may be turned off) or the set temperature of the fixing section heater in the image forming section 4 may be lowered.

In security mode, normal operations that activate and use the copy function, printer function, scanner function, and fax function are unable to be utilized. Namely, input that is made by user manipulation during normal operations in order to start the operations of each function is not accepted. For example, processing and the like may be performed so that normal key operations on the operating section 5 are not accepted, and reading operations or the like of the copy function may not be performed. As a result, in security mode functional operations that have converted to power saving mode and are temporarily suspended are not restored by a normal operation.

Furthermore, in security mode, background processing relating to each of the functions whose operations are temporarily suspended may be appropriately executed. For example, in background processing relating to the copy function or scanner function, the control unit 1 determines whether or not unnecessary data is present in memory such as RAM or in the storage section 2 (step S4). If unnecessary data is present (i.e., if the result of the determination in step S4 is YES), the unnecessary data is deleted (step S5). The delete processing at this time is delete processing based on overwriting that makes the unnecessary data irreproducible. Note that if there is no unnecessary data (i.e., if the result of the determination in step S4 is NO), the routine moves immediately to the next processing step.

In a digital camera and the like, data of images that is obtained by a scan using the copy function is temporarily stored, however, there are cases when this temporary data remains in the memory as long as the power is not turned off. Therefore, in this MFP, if this temporary data includes unnecessary data that does not need to be left in memory, it is deleted by the background processing in security mode (steps S4 and S5). Other processing modes relating to other functions also exist for this type of background processing in security mode. These are described specifically below (in Background processing mode).

This MFP that has converted into security mode then monitors whether there is any input to commence security mode termination processing (step S6). This input may be an optional signal input such as input made by a key operation using the operating section 5, fax receiving input using the fax transmitting and receiving section 8, and printing data receiving input using the network communication section 9. While there is no such input (i.e., while the result of the determination in step S6 is NO), operations of the power saving mode and the security mode are maintained unchanged, however, if, for example, a user operates an arbitrary key on the operating section 5, the control unit 1 determines that there has been an input (i.e., the result of the determination in step S6 is YES) and security mode termination processing is commenced.

In the security mode termination processing, an authorization process based on password input is implemented, and a decision as to whether or not to permit normal running operations, namely, whether or not to restore functional operations that had converted to power saving mode and were in a temporarily suspended state. Consequently, a password input screen is displayed on the display unit 6 and a request is made for a password to be input. In addition, in this MFP, a timer commences measuring time from the point when this password input screen is displayed (step S7). The timer referred to here is a timing device formed by a software timer (i.e., a counter for measuring time) stipulated in the security mode program and provided in the control unit 1, and measures the wait time that the password input screen is displayed and the MFP is waiting for a password to be input.

In this MFP, the control unit 1 determines whether or not the wait time measured by this timer has reached the security mode reconversion time stipulated in the above described settings, and determines whether or not the security mode reconversion time has lapsed during this password input standby state (step S8). The control unit 1 monitors password input (step S9) until the security mode reconversion time has elapsed (i.e., while the result of the determination in step S8 remains NO), and maintains the password input standby state even if no input is made (i.e., the routine remains at the determination processing of steps S8 and S9 when the result of the determination in step S9 as well is also NO).

If a user inputs a password by operating the keys on the operating section 5 while this password input standby state is being maintained, the control unit 1 compares the input password with a password that has been set in advance, and determines whether or not the password is correct (i.e., the result of the determination in step S9 is YES and the routine moves to step S10). If the password is correct (i.e., if the result of the determination in step S2 is YES), normal running operations are permitted and the security mode is terminated. At the same time, the operation of the power saving mode is ended, and the function operations that had been temporarily suspended are restored. As a result, normal operations are restored and the MFP changes to a state in which normal use is possible. In addition, processing to implement operations of the power saving and security modes is ended. If the password is not correct (i.e., if the result of the determination in step S10 is NO), then the password input screen is once again displayed on the display unit 6 and a password input is sought. The timer measurement is once again commenced from the point in time when this password input screen is displayed and the apparatus again enters a password input standby state (i.e., the routine returns from step S10 to S7, and thereafter stays at the determination processing of steps S8 and S9 as is described above). In an image forming apparatus that is shared by a plurality of users, because some parts are not safe from a security viewpoint, in this MFP, the security can be strengthened by employing a mode in which the MFP is not restored to a usable state unless a password is input when the MFP is restored after converting to security mode each time it converts to power saving mode.

In contrast to this, if the password input standby state continues and the wait time reaches the security mode reconversion time, and the security mode reconversion times lapses without any password being input, this MFP converts again to power saving mode and security mode (i.e., the result of the determination in step S8 changes to YES and the routine returns to step S3). Namely, if this MFP is left alone in a password input standby state and the security mode reconversion time elapses, it is restored to the power saving mode and security mode operating states that existed prior to the commencement of the security mode termination processing. For the security mode, because, for example, the password input screen is displayed and timer measurement is conducted as a result of the commencement of the termination processing, the display of the password input screen and the timer measurement are suspended. For the power saving mode, of the suspended operations those that had been restored by the starting of the termination processing are again suspended. For example, the screen display of the display unit 6 that had been turned on in order to display the password input screen is turned off, and display operations of the display unit 6 are again suspended.

Here, because the security mode reconversion time is set at half the power saving mode conversion time, if this MFP is left in a password input standby state, the MFP returns from the normal operation standby state to the power saving mode and security mode operating states in half the time taken to convert to power saving mode. Accordingly, in this MFP, the reconversion from the password input standby state to the power saving mode and security mode takes a shorter time than the time taken to convert from an unused state to a power saving mode (when a reconversion is being performed, it is not necessary to wait for the length of time required for a normal conversion), and the password input standby state does not continue for an unnecessarily long time.

For example, if a person who is unaware of the password (i.e., a person who is also unaware that the MFP converts to security mode at the same time as it converts to power saving mode) attempts to use this MFP illegally when the MFP has converted to power saving made and security mode, the MFP enters the password input standby state and is left alone without the password being acknowledged. The password input screen remains displayed on the display unit 6. However, because this MFP reconverts to power saving mode in a shorter time that it takes to convert from an unused state to a power saving mode, a situation in which the password input screen is continuously displayed for an unnecessarily long time is avoided, and it is possible to prevent any power consumption that might negate the purpose of the power saving mode.

Moreover, conventionally, even if the user is a legitimate user who knows the password there may still be cases when that user forgets the password or inputs an incorrect password thinking it is the correct one. Therefore, a legitimate user is now able to first place the MFP in a password input standby state and then go somewhere else in order to check the password leaving the MFP in the password input standby state. Although such actions may not be preferable from the viewpoint of security, this MFP converts to power saving mode and security mode in a shorter time so that the password input waiting screen is not left displayed for an extended period of time. Accordingly, there is no longer any unnecessarily long notification that a password is required for an MFP to be restored from power saving mode, and other users are no longer burdened with unnecessary tasks in order to terminate extended unused states.

According to this MFP, suitable processing can be performed when there is no password input and appropriate security control for function use can be achieved. After the MFP has converted once again to power saving mode and security mode with no password being input, in the same way as is described above, background processing is appropriately executed (steps S4 and S5), input to start security mode termination processing is monitored (step S6), and if there is some input an authorization process based on a password input is implemented as is described above (steps S7 to S1). If the correct password is input within the security mode reconversion time, the MFP returns to normal operations and processing is ended. In addition, if the security mode reconversion time elapses, the MFP returns once again to the power saving mode and security mode that existed prior to the start of the termination processing and the same processing is repeated. As a result, the effectiveness of the security mode is ensured and a reduction in power consumption can be achieved. Moreover, the security mode is also used effectively and it is possible to prevent the MFP being restored from power saving mode as a result of the improper use or erroneous use of each function, so that a user's information and the like can be protected.

Note that if a conversion (transition) to security mode at the time of a conversion (transition) to power saving mode is rendered invalid in the above described settings and the power saving mode conversion time then elapses, it is determined by the control unit 1 that refers to these settings that a security mode conversion in invalid, and the MFP executes normal power saving mode operations (i.e., the result of the determination in step S2 is NO and the routine moves to step S11). Normal power saving mode operations are processing operations performed only by a power saving mode program without any accompanying conversion to security mode, and only the above described power saving mode operation is implemented and the power saving mode is terminated by an optional input. Because of this, the control unit 1 monitors input (step S12) and while there is no input (i.e., while the result of the determination in step S12 is NO), power saving mode operations are maintained unchanged. However, if an input is received (i.e., if the result of the determination in step S12 changes to YES), the power saving mode is terminated, normal operations are restored and the processing is ended.

(Security Mode Reconversion Time Setting Mode)

The fundamental operations of the power saving mode and security mode of this MFP are described above, however, the security mode reconversion time is a setting that is unique to this MFP, as is described above, and various modes exist for the security mode reconversion time being set. The setting to make the security mode reconversion time half the power saving mode conversion time which is described in the above operation description is an example of a setting that is made after considering the relationship with the power saving mode conversion time from the fact that the state in which function operations are temporarily suspended due to the MFP converting (executing transition) to power saving mode is the object to which the security mode is applied. Because it can be said that after the MFP has converted to power saving mode the time until reconversion should be as short as possible, it is preferable for a short time of less than half the power saving mode conversion time to be set for the security mode reconversion time.

Moreover, because the power saving mode conversion time may be set by a user in accordance with the circumstances of the function use, it is also possible to select a suitable security mode reconversion time to match each set power saving mode conversion time. For example, for a user who frequently uses the copy function, because time is needed for the MFP to be restored once it has converted to power saving mode, it might be common for a long power saving mode conversion time to be set. On the other hand, for a user having a low level of function use, it might be common for a short power saving mode conversion time to be set so as to achieve a reduction in power consumption. If the setting of the security mode reconversion time is considered on the basis of such factors, then the following mode is an example of an appropriate setting.

if the power saving mode conversion time is ≧60 minutes, the security mode reconversion time is set to 20 minutes.

if the power saving mode conversion time is <60 minutes and >3 minutes, the security mode reconversion time is set to ⅓^{rd} the power saving mode conversion time.

if the power saving mode conversion time is ≦3 minutes, the security mode reconversion time is set to 1 minute.

Furthermore, because it is also possible to make operating states in other operating modes the object to which the security mode is applied, or to implement operations in security modes in different modes from those in the above operation description, it is also possible for the security mode reconversion time to be suitable set in accordance with the situation in which the security mode operations are implemented. The important thing when setting of a security mode reconversion time is that it is set to a shorter time than the time taken to convert from a normal operating state to a security mode (i.e., the power saving mode conversion time in the above example).

(Background Processing Mode)

Background processing in the above described security mode is processing relating to the respective functions whose operations have been temporarily suspended by the conversion to power saving mode. The processing to delete unnecessary data in steps S4 and S5 shown in FIG. 2 is an example of background processing relating to the copy function or scanner function. The MFP of the present invention is further provided with a printer function and a fax function and examples of background processing that are executed in security mode relating to these functions include the following.

(1) Background Processing Relating to the Printer Function

When the printer function is used, print data is transmitted from another computer that is connected on a network by the server function of this MFP, and the control unit 1 receives the print data via the network communication section 9. The background processing relating to the printer function is executed when this print data transmission occurs during operations of the power saving mode and security mode.

In background processing relating to the printer function, only the receiving of the print data is performed and no print output is executed. Accordingly, the control unit 1 that has received the print data activates memory such as RAM or the storage section 2 and saves the print data, however, the image forming section 4 is not activated (i.e., image forming processing is not executed and the state of the image forming section 4 is maintained in power saving mode). It is also possible for the computer that sent the print data to be notified by a display on the display unit thereof that the MFP is in security mode. This type of background processing is executed in addition to the above described processing of steps S4 and S5 in the area described as “Background processing” and shown by the broken line in the processing sequence shown in FIG. 2.

The print output of the print data received in the background processing may be executed once the MFP that has completed an authorization process using password input such as that described above has been restored to normal operations, however, it is also possible for the print output to be executed by this MFP exchanging information with the computer that sent the print data in order to perform processing that corresponds to the same authorization process.

For example, if a legitimate user of the MFP clicks an OK button on a print menu displayed on a screen of the display unit of a computer terminal that is connected by a network to this MFP (i.e., performs a send print data operation), a request is made from the MFP to the relevant computer for a password to be input. In this case, the input of the reception signal of the received print data forms an input that starts processing to terminate the security mode. The MFP starts the timer measurement from the point in time when the password input screen is displayed on the display unit of the relevant computer, and enters a password input standby state in the same manner as is described above (i.e., the result of the determination in step S6 is changed to YES as a result of the print data being received, and the routine moves to the processing of steps S7, S8, and S9). As a result, if inputs the correct password on the input device of the relevant computer before the security mode reconversion time lapses, the security mode is terminated in the MFP that receives the password (i.e., the result of the determination in step S10 changes to YES and normal operations are restored), the image forming section 4 is activated, and a print output of the print data transmitted by the user is executed.

Here, due to its function as a server, the MFP is able to ascertain which terminal was the transmission source of the received print data. Accordingly, the password that permits use of the printer function can also be restricted to being a password solely for a specific user who uses the computer terminal that is the source of the print data. Namely, a password may be set in advance for each user, and when print data is received while a security mode is in operation, only the password of the user of that terminal that sent the print data is accepted. As a result, it is possible in the security mode termination processing for authorization to be given for a specific person to use the printer function, and control of security can be implemented over the use of each individual terminal accessing this MFP.

(2) Background Processing for the Fax Function

A fax transmitting function and a fax receiving function constitute the fax function. Because faxes from the outside arrive in the same manner when the MFP has converted to security mode as when it is operating normally, it is necessary in the fax receiving function in particular to execute background processing to receive inward faxes while the MFP is in power saving mode and security mode.

In background processing relating to the fax receiving function, only the receiving of inward faxes is performed and no print output is made of the received inward fax. Accordingly, when the control unit 1 receives an image signal that has been transmitted from a fax line via the fax transmitting and receiving section 8, it activates memory such as RAM or the storage section 2 and saves the image signal fax data, however, the image forming section 4 is not activated (i.e., image forming processing is not executed and the state of the image forming section 4 is maintained in power saving mode). It is also possible for a predetermined notification sound to be generated by the notification section 7 to give notification that an inward fax has been received. This type of background processing is executed in addition to the above described processing of steps S4 and S5 in the area described as “Background processing” and shown by the broken line in the processing sequence shown in FIG. 2.

The print output of the inward fax received in the background processing may be executed once the MFP that has completed an authorization process using password input such as that described above has been restored to normal operations, however, it is also possible for the MFP to display on the display unit 6 when the MFP receives the inward fax the fact that an inward fax that has not yet been output and whose fax data has been saved has arrived, and to start the security mode termination processing. Namely, because, as is described above, a fax reception input in the fax transmitting and receiving section 8 may be an input that starts security mode termination processing, a password input screen that also shows the fact that an inward fax has been received is displayed on the display unit 6, and the MFP may enter the same password input standby state as is described above (i.e., the result of the determination in step S6 is changed to YES by the arrival of the inward fax, and the routine advances to the processing of steps S7, S8, and S9). As a result of this, if a user inputs the correct password by a key operation on the operating section 5 prior to the security mode reconversion time elapsing, in this MFP, the security mode is terminated (i.e., the result of the determination in step S10 changes to YES and normal operations are restored), the image forming section 4 is activated, and a print output of the received fax is executed.

Here, the password that permits use of the fax receive function may be a password shared by legitimate users, and, like a password that permits use of the printer function, does not have to be set separately for each user (typically, in the case of the fax receiving function, no request is made to authorize a specific person). However, only specific users are made aware of this common password and it is possible for authorization for specific people (or some similar authorization) to be performed.

(3) Background Processing Using an Encryption Box

Background processing using the printer function and that using the fax function are the same in that, as is described above, they accumulate received data but do not make a print output. Therefore, it is possible to employ a structure in which, for example, the storage section 2 is provided with a storage area such as an encryption box that encodes and saves data, and then temporarily save received data in this storage area while the security mode is in operation. By employing this structure, the received data is safely stored in background processing and an even greater degree of security control can be achieved.

(Other Transformations and Applications)

(1) Password Input

In the operation description given above, the MFP enters the password input standby state if an input password is incorrect, however, it is also possible to limit the number of password input attempts to a predetermined number. Namely, if the password is consecutively input incorrectly for a predetermined number of times, then the MFP can be set so as to return to the power saving mode and security mode operating states prior to the start of the termination processing irrespective of the length of the wait time.

Moreover, in the operation description given above, a method is employed in which, if the password is incorrect, the timer measurement is recommenced (i.e., the timer is reset and the measurement is restarted) after the MFP has returned to a password input standby state, however, it is also possible to employ a method in which the timer measurement continues (i.e., the timer is not reset even if the password input standby state is restored) even if the password is incorrect. Furthermore, it is also possible even in cases such as when the timer measurement is continued in this manner for the number of password input attempts to be limited to a predetermined number as is described above.

Note that a password is an example of authorization information used in authorizing security mode termination processing, and it is also possible to employ a structure in which biological information such as a fingerprint or authorization information such as a personalized number is used for the authorization information.

(2) User Operation

A user operates this MFP mainly by performing key operations using the operating section 5, however, a structure may also be employed in which the MFP is operated using a computer terminal that is connected via a network to the MFP. An example of this is the above described operation to restore normal running from background processing of the printer function.

Namely, by exchanging information with the control unit 1 via the network communication section 9, it is possible for a computer that is connected via a network to this MFP to input information into the MFP as a terminal that has this MFP as its server. Therefore, the same screen as that displayed on the display unit 6 can be displayed on the display unit of a computer that is connected via a network to the MFP, and the MFP can be operated by the user operating the input device of this computer. For example, settings such as the power saving mode conversion time, the validation or non-validation of a security mode conversion at the time of the power saving mode conversion, the password, and the security mode reconversion time may be made by a user at their own computer terminal.

(3) Security Mode Application Modes

In the above described embodiment, the object to which security mode is applied is the function operation temporarily suspended state that is created by the conversion to power saving mode, however, it is also possible for the security mode to be applied to operating states in other modes. For example, operating states to which the security mode may be applied include operating modes that are similar to the above described power saving mode such as those known as suspend modes, screen savers, low power modes, and sleep modes, operating modes in which the display is simply turned off, operating modes in which the screen display of the display unit is simply switched to another display, and operating modes in which the display of the display unit is simply locked.

Namely, in the same manner as is described above, the security mode can be applied to operating modes that render at least one normal function invalid, and the power saving mode is nothing more than one example of such. In addition, when the security mode is applied, the security mode reconversion time is set to a time that is shorter than the time it takes the relevant function to convert from a valid state to the relevant operating mode.

Moreover, in the above described embodiment, the conversion to security mode is made to take place at the same time as the conversion to power saving mode, however, it is not absolutely necessary for the conversion to security mode to take place at the same time as the conversion to the operating mode being applied. For example, in the above described embodiment, it is also possible to employ a method in which the conversion to security mode is made to occur prior to or after the conversion to power saving mode. Furthermore, in cases such as when the time required to convert to the operating mode being applied is irregular, the security mode conversion time for converting to security mode in conjunction with the relevant operating mode (i.e., a time corresponding to the power saving mode conversion time) is set in advance, and a time that is shorter than this security mode conversion time is set in advance as the security mode reconversion time. The security mode reconversion time in this case may be set after assuming a case in which the relevant operating mode was about to be terminated, however, it was not actually terminated but was left untouched, and after considering the maximum time and the like that this untouched state can be accepted.

As a result of the above, it is possible to separately implement only the security mode operation. In this case, conditions for converting to security mode including the security mode conversion time are set in advance, and a time that is shorter than this security mode conversion time is set as the security mode reconversion time.

(4) Subject Instruments

In the above described embodiment, the subject instrument to which the security mode operation was applied was an MFP, however, the security mode operation can also be applied to various other instruments. For example, this security mode operation can also be applied to computers such as personal computers, portable devices such as mobile phones and personal digital assistants (PDA), remote controllers, photocopiers or duplicating machines, printers, scanners, fax machines, and other electrical products.

Here, computers and portable devices and the like are commonly provided with operating modes similar to the above described power saving mode such as a screen saver or a sleep mode, and security control using these security modes can also be performed in the same manner as in the above described embodiment. In particular, because notebook type personal computers and mobile phones and the like have a rechargeable battery for their power source, the function of reducing power consumption by implementing the security mode operation is strengthened, and the life of the battery can be lengthened.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A security control apparatus comprising:
a transition device that, when a preset transition time has elapsed, executes transition to a first state of a security mode in which function use by normal operation of an instrument is disallowed;
an input requesting device that, in the security mode, requests an input of authorization information that is used for authorization to permit the function use; and
a restoring device that, when a preset re-transition time that is shorter than the transition time has elapsed while in a second state of waiting for the input of the authorization information, restores the first state of the security mode.

2. The security control apparatus according to claim 1, wherein
the transition time is the duration of a period of non-use of the instrument in which it executes transition to an invalid mode that invalidates at least one function of the instrument,
the transition device executes transition to the security mode at the same time as it executes transition to the invalid mode when the transition time has elapsed.

3. The security control apparatus according to claim 2, wherein the invalid mode places function operations of the instrument in a temporarily suspended state.

4. The security control apparatus according to claim 1, wherein the instrument is an image forming device having a storage device that temporarily saves data of a read image, and there is further provided a deleting device that, when temporarily saved data is remaining in the storage device, deletes the data in the security mode.

5. The security control apparatus according to claim 1, wherein the instrument is an image forming device having a function of receiving print data and executing a print output, and there are further provided: a first print restricting device that, when the image forming device receives print data while in the security mode operating state, saves the print data but does not allow a print output of the image forming device to be executed; and a first print executing device that, when the authorization information is input and the function use is permitted, causes a print output of the print data on the image forming device.

6. The security control apparatus according to claim 1, wherein the instrument is an image forming device having a function of receiving a fax and executing a print output, and there are further provided: a second print restricting device that, when the image forming device receives a fax while in the security mode operating state, saves the received fax data but does not allow a print output of the image forming device to be executed; and a second print executing device that, when the authorization information is input and the function use is permitted, causes a print output of the received data on the image forming device.

7. A security control method comprising:
a first step of, when a preset transition time has elapsed, executing transition to a first state of a security mode in which function use by normal operation of an instrument is disallowed;
a second step of, in the security mode, requesting an input of authorization information that is used for authorization to permit the function use; and
a third step of, when a preset re-transition time that is shorter than the transition time has elapsed while a second state of waiting for the input of the authorization information still exists, restoring the first state of the security mode.

8. A storage medium that executes on a computer, comprising:
a first procedure in which, when a preset transition time has elapsed, executing transition to a first state of a security mode in which function use by normal operation of an instrument is disallowed;
a second procedure in which, in the security mode, requesting an input of authorization information that is used for authorization to permit the function use; and
a third procedure in which, when a preset re-transition time that is shorter than the transition time has elapsed while a second state of waiting for the input of the authorization information still exists, restoring the first state of the security mode.
